(19) United States
(12) Patent Application Publication
(10) Pub. No.: US 2010/0110389 A1
(43) Pub. Date: May 6, 2010

(54) Laser projection system

(75) Inventors: Cheng-Shun Liao, Hsin-Chu (TW); Chu-Ming Cheng, Hsin-Chu (TW); S-Wei Chen, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Young Optics Corporation, Hsin-Chu (TW)

(21) Appl. No.: 12/588,944

(22) Filed: Nov. 3, 2009

(30) Foreign Application Priority Data
Nov. 5, 2008 (TW) 097142629

(51) Int. Cl. G03B 21/14

(52) U.S. Cl. 353/31; 353/20

(57) ABSTRACT

A laser projection system includes a plurality of laser light sources, a light combining module, an image generating module, a lens, a diffusion module. and a projection lens. The laser light sources are used to provide a plurality of light beams with different colors. The light combining module is disposed in the light path of the laser beams for mixing the laser beams to form a mixing light beam. The image generating module is disposed in the light path of the mixing light beam for receiving the mixing light beam to generate a first image. The lens is disposed in the light path of the first image and provides an imaging position. The first image passes through the lens to form a second image at the imaging position. The diffusion module includes a diffuser and an actuator. The projection lens projects the second image on a screen.

### BACKGROUND OF THE INVENTION

(1) Field of the Invention

The present invention relates to a projection system, and more particularly, to a projection system using a laser as a light source.

(2) Description of the Prior Art

A projector is constituted of a light source, an illuminating module, an image generating module and so on. The illuminating module has an integration rod and a focusing lens, etc. The image generating module has a light engine and a projection lens, etc. The light beam is emitted from the light source and passes through the integration rod, the focusing lens, and the light engine to form an image beam, and then the image beam is projected on a screen through the projection lens to form an image. Generally, the light source may be a lamp, a light emitting diode (LED) or a laser light source. The projectors may be classified into liquid crystal panels, liquid crystal on silicon panels (LCOS panel), and digital micro-mirror devices (DMD).

In recent years, the development of the projector becomes very quickly, and the micro projector has become a new trend in the projector market. Luminous efficiency of the light source is the key factor in the development of the projector. Conventional projectors use light emitting diodes (LEDs) as light sources but the photoelectric converting efficiency is limited. Accordingly, it is promoted that manufacturers of projectors seek a better light source.

Comparing a laser light source with LED and an incandescent bulb, the laser light source has higher photoelectric converting efficiency and color saturation degree. Thus, some manufacturers have already replaced the LED with the laser light source.

Refer to FIG. 1 for a conventional laser projection system 100. The laser projection system 100 includes red, green, and blue (RGB) laser light sources 120r, 120g, and 120b, a light combining module 140, a light engine 160, and a projection lens 180. The laser light beams from the laser light source 120r, 120g, and 120b are mixed into a white light by the light combining module 140. The white light passes through the light engine 160 to form an image beam, and the image beam is projected on a screen 200 via the projection lens 180.

Laser light is coherence and it is a high energy and preferred orientation light beam with the same wavelength, identical phase, and a single frequency. However, when the laser is used as the light source of a projector, laser speckles appear.

When the laser is projected on a screen, it is reflected by the rough surface of the screen to form a lot of reflected waves. After these reflected waves are received by an image receiver (human eyes), interference phenomenon and light spots come out. The laser speckles interrupt the normal appearance of the image. Thus, how to decrease the laser speckles is a main subject in the popularization of the laser projection technology.

The traditional way of eliminating the laser speckles is adding an actuating mechanism 220, for example, a motor, for the screen 200, which keeps the screen 220 moving or rotating to corrupt the coherence of the laser light for further decreasing interference.

The conventional screen 200 is very large, and the actuating mechanism 220 may be large enough to drive the screen 200, which is inconvenient in application and also has problems about noise and shock resistance in the product reliability test.

### SUMMARY OF THE INVENTION

The present invention is to provide a laser projection system capable of improving the phenomenon of the laser speckles on the image.

For achieving one, some or all of the above mentioned object, a laser projection system is provided as an embodiment of the present invention. The laser projection system includes a plurality of laser light sources, a light combining module, an image generating module, a lens, a diffusion module, and a projection lens.

These laser light sources provide a plurality of laser light beams with different colors. The light combining module is disposed in the light path of the laser light beams for mixing the laser beams to form a mixing light beam. The image generating module is disposed in the light path of the mixing light beam for receiving the mixing light beam to generate a first image. The lens is disposed in the transmitting path of the first image for providing an imaging position. The first image is capable of passing through the lens to form a second image at the imaging position. The diffusion module includes a diffuser and an actuator. The diffuser is disposed at the imaging position of the lens, and the actuator is connected to the diffuser. The projection lens is disposed in the transmitting path of the second image for projecting the second image on a screen.

In one embodiment, the image generating module includes a transparent liquid crystal panel. The lens is a relay lens. An illuminating module is disposed in the light path of the mixing light beam and between the light combining module and the transparent liquid crystal panel. The illuminating module includes a focus lens, an integration rod, and a plurality of relay lenses, and the focus lens is disposed between the light combining module and the integration rod, and the integration rod is disposed between the focus lens and the relay lenses.

In one embodiment, the image generation module includes a reflective liquid crystal panel and a polarization beam splitter. An illuminating module is disposed in the light path of the mixing light beam, and between the light combining module and the reflective liquid crystal panel. The illuminating module includes a fly eye lens and a plurality of relay lenses, and the fly eye lens is disposed between the light combining module and the relay lenses.

In one embodiment, the image generating module includes a plurality of one-dimensional scanning lenses. The lens is an f-theta lens.

In above embodiments, the laser light sources includes a red laser light source, a blue laser light source, and a green laser light source. The light combing module includes two parallel dichroic mirrors. The actuator of the diffusion module is capable of driving the diffuser selectively moving in two different directions at a predetermined frequency. In addition, the diffuser of the diffusion module may be a disc. A motor is used as the actuator for rotating the diffuser.

The embodiments of the present invention uses the lens to focus the image formed by the image generating module on the moveable or rotatable diffuser, so as to corrupt the coherence of the laser light for further decreasing the laser speckle of the image.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view of a conventional laser projection system.

FIG. 2. is a schematic view of a laser projection system in accordance to with an embodiment of the present invention.

FIG. 3 is a schematic view of a laser projection system with a transparent liquid crystal panel in accordance with an embodiment of the present invention.

FIG. 4 is a schematic view of a laser projection system with a reflective liquid crystal panel in accordance with an embodiment of the present invention.

FIG. 5 is a schematic view of a laser scanning projection system in accordance with an embodiment of the present invention.

FIG. 6 is a schematic view of a diffusion module of a laser projection system in accordance with an embodiment of the present invention.

FIG. 7A and FIG. 7B are schematic views of a diffusion module of a laser projection system in accordance with an embodiment of the present invention.

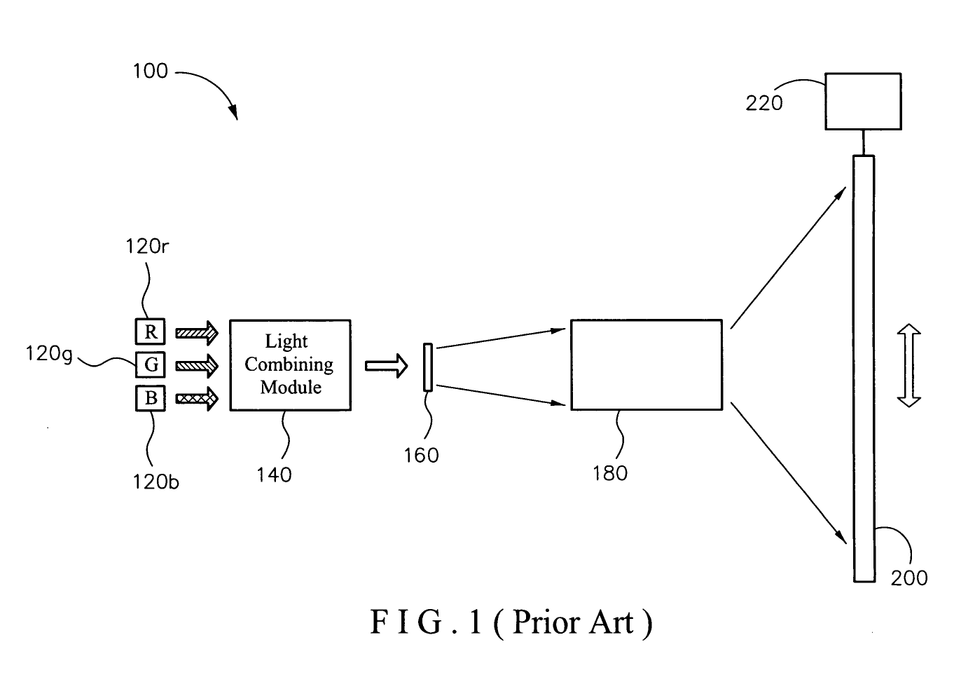

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no to way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

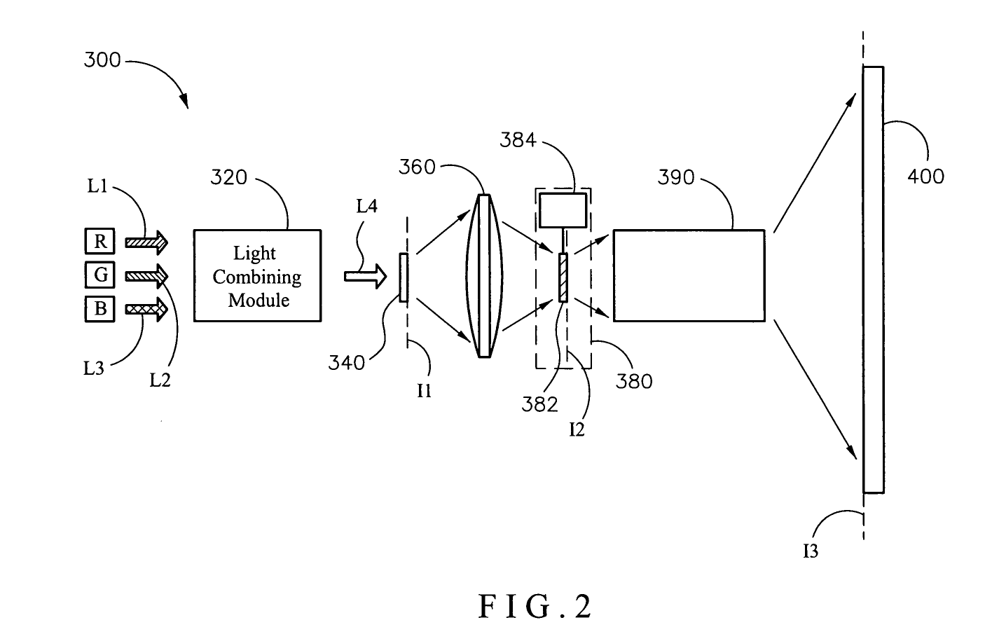

Referring to FIG. 2, a laser projection system 300 includes a plurality of laser light sources R, G, and B, a light combining module 320, an image generating module 340, a lens 360, a diffusion module 380, and a projection lens 390.

The laser light sources R, G, and B are used to provide laser light beams with different colors respectively. For example, the laser light source R provides a red laser light beam L1, the laser light source G provides a green laser light beam L2, and the laser light source B provides a blue laser light beam L3. The light combining module 320 is disposed in the light path of the laser light beams L1, L2, and L3 for mixing the laser light beams L1, L2, and L3 into a mixing light beam L4.

The image generating module 340 is disposed in the light path of the mixing light beam L4 for receiving the mixing light beam L4 to generate a first image I1. Noticeably, the lens 360 is disposed in the transmitting path of the first image I1 and provides an imaging position. The first image I1 passes through the lens 360 for forming a second image I2 at the imaging position. The diffusion module 380 includes a diffuser 382 and an actuator 384. The diffuser 382 is disposed at the imaging position of the lens 360 and is connected to the actuator 384 for controlling the movement and rotation of the diffuser 382. The projection lens 390 is disposed in the transmitting path of the second image I2 for projecting the second image I2 on a screen 400 to form a colorful projection image I3.

That is to say, the projection lens 390 has a physical object surface and a physical image surface. The diffuser 382 is disposed on the object surface, and the screen 400 is disposed on the image surface. Thus, the projection lens 390 treats the second image I2 on the diffuser 382 as a physical object and projects the second image I2 on the screen 400 for forming the colorful projection image I3.

The diffuser 382 of the present embodiment has an irregular rough surface, which disperses the laser light beam of the second image I2 to decrease the orientation of the laser light beam. The diffuser 382 may move or rotate to disrupt the coherence of the laser light to further avoid the laser speckles forming on the projection image I3. Moreover, the diffuser 382 is disposed at the imaging position of the lens 360 that is the imaging position of the second image I2. The projection image I3 received by human eyes is an image formed by the lens 390 projecting the second image I2 on the screen 400. Therefore, it is useful to decrease the laser speckles on the projection image I3 by disposing the diffuser 382 at the imaging position of the second image I2 and moving or rotating the diffuser 382 to disrupt the coherence of the laser light beam of the second image I2.

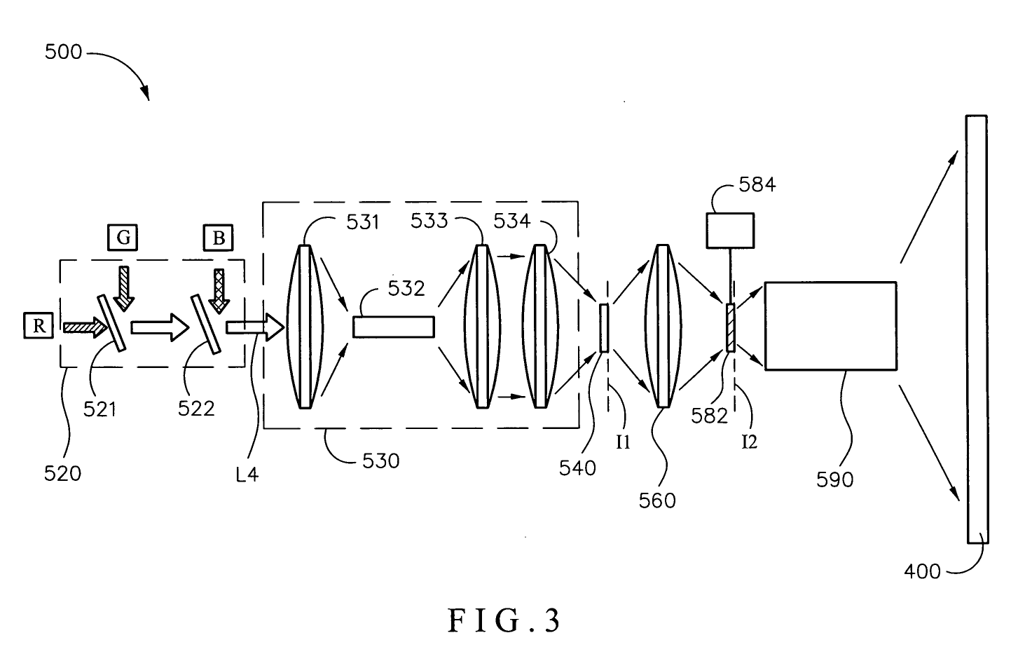

Referring to FIG. 3 to FIG. 5, laser projection systems 500, 600 and 700 in following three embodiments have the same basic structure as the laser projection system 300 in FIG. 2. The image generating modules of the laser projection systems 500, 600 and 700 adopt a transparent liquid crystal panel 540, a reflective liquid crystal panel 641 cooperating with a polarization beam splitter (PBS) 642, and scanning lenses 741 and 742 respectively.

Referring to FIG. 3, the light combining module 520 of the laser projection system 500 has two parallel dichroric mirrors (DM) 521 and 522. An illuminating module 530 is disposed in the light path of the mixing light beam L4 and between the light combining module 520 and the transparent liquid crystal panel 540 for homogenizing the mixing light beam L4. The illuminating module 530 has a focus lens 531, an integration rod 532, and a plurality of relay lenses 533 and 534. The focus lens 531 is disposed between the light combining module 520 and the integration rod 532, and the integration rod 532 is disposed between the focus lens 531 and the relay lenses 533 and 534. In the present embodiment, a relay lens 560 is disposed behind the transparent liquid crystal panel 540 and has the same function as the lens 360 in FIG. 2.

The red, green and blue laser light beams R, G, and B are mixed into a white light beam by the light combining module 520. After passing through the focus lens 531, the white light beam is focused at the integration rod 532 and homogenized by the integration rod 532. The light beam from the integration rod 532 passes through the relay lenses 533 and 534 to concentrate on the transparent liquid crystal panel 540. After processing an image process of the transparent liquid crystal panel 540, the first image I1 is formed. The second image I2 is formed on the diffuser 582 by the first image I1 through the relay lens 560.

The diffuser 582 is controlled by the actuator 584 to move up and down, left and right (biaxial direction) or rotate as well as to adjust the movement frequency or the rotation speed. Then, the second image I2 on the diffuser 582 is projected on the screen 400 through the projection lens 590.

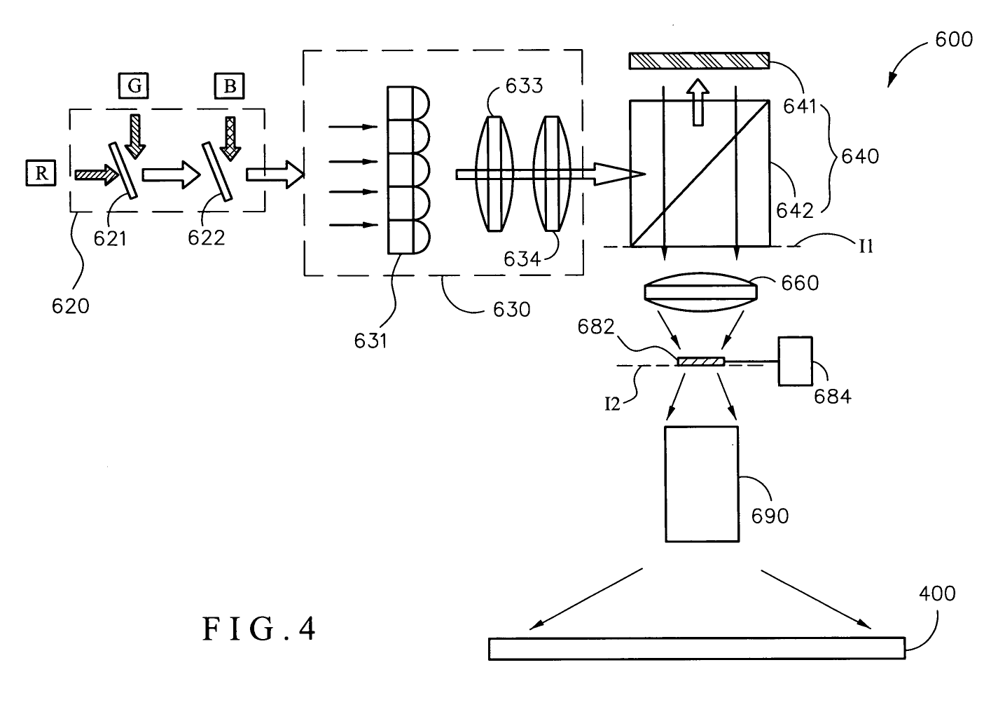

Referring to FIG. 4, a light combining module 620 of a laser projection system 600 has two parallel dichroric mirrors 621 and 622 and has the same structure and function as the light combining module 520 in FIG. 3. In the present embodiment, the illuminating module 630 includes a fly eye 631 and a plurality of relay lenses 633 and 634. The fly eye 631 is disposed between the light combining module 620 and the relay lenses 633 and 634 and has functions of collimation, focusing, homogenizing, and beam splitting. The image generating module 640 includes a reflective liquid crystal panel 641 and a polarization beam splitter 642.

The reflective liquid crystal panel 641 may be a liquid crystal on silicon (LCOS) panel. The polarization beam splitter 642 is constituted of two isosceles right angle prisms whose bottoms are stuck together and able to reflect S polarized light (polarization direction is vertical to the incident direction) and allow P polarized light (polarization direction is parallel to the incident direction) to pass through.

The working principle of the image generating module 640 in FIG. 4 is described as follows. The mixing light beam (white light) from the illuminating module 630 is incident to the polarization beam splitter 642 which reflects the S polarized light of the mixing light beam to the reflective liquid crystal panel 641 and allows the P polarized light of the mixing light beam to pass through. If the first image I1 from the image generating module 640 has dark pixels, the liquid crystal units corresponding to the dark pixels in the reflective liquid crystal panel 641 are closed. The closed liquid crystal units reflect the S polarized light back to the polarization beam splitter 642, but the S polarized light cannot pass through the polarization beam splitter 642. The liquid crystal units corresponding to the bright pixels in the first image I1 convert the incident S polarized light into the P polarized light, so as to pass through the polarization beam splitter 642.

The first image I1 outputted from the polarization beam splitter 642 passes through the relay lens 660 to form the second image I2 on the diffuser 682 controlled by the actuator 684, and then the second image I2 is projected on the screen 400 by the projection lens 690.

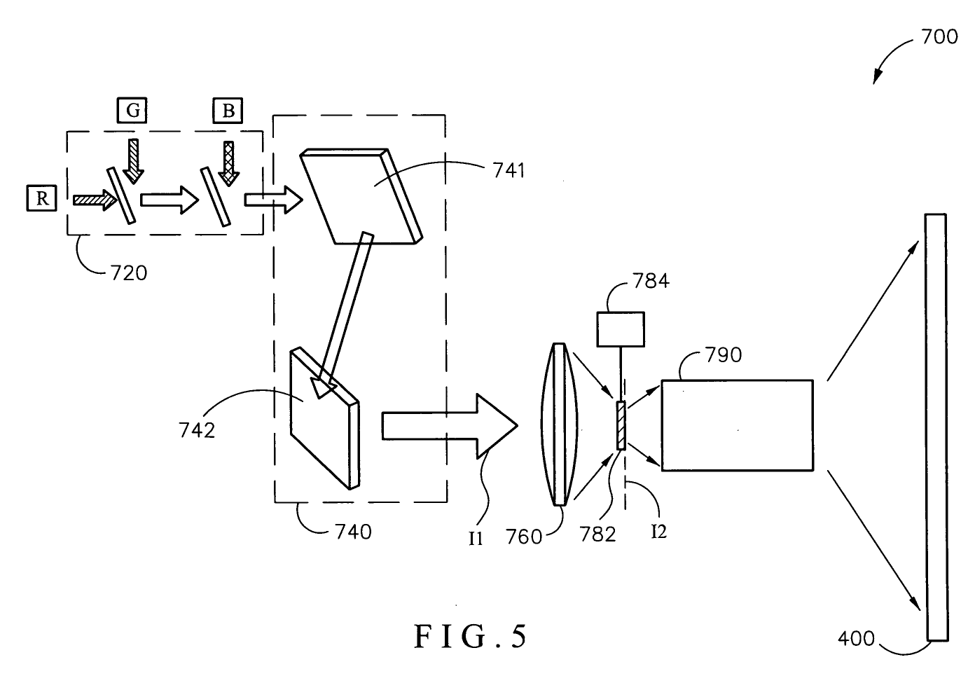

Referring to FIG. 5 for an embodiment of a laser scanning projection system 700. A light combining module 720 in the present embodiment has the same structure and functions as above embodiments. The white light from the light combining module 720 passes through an image generating module 740 including two one-dimensional scanning lenses 741 and 742 to form the first image I1. Noticeably in the present embodiment, a light homogenizing mechanism such as an illuminating module may not be disposed between the light combining module 720 and the image generation module 740.

The above two one-dimensional scanning lenses 741 and 742 are two uniaxial rotating mirrors, which can make the light beam scan left and right, up and down on the mirror and be reflected out with a particular angle. In another embodiment, it may be a biaxial rotating mirror called two-dimensional scanning lens for achieving the same efficacy as the two one-dimensional scanning lenses 741 and 742.

After the first image I1 is generated by the image generating module 740, the first image I1 passes through an f-theta lens 760 to focus on the diffuser 782 controlled by the actuator 784 and forms a second image I2 which and then the second image I2 is projected on the screen 400 by the projection lens 790.

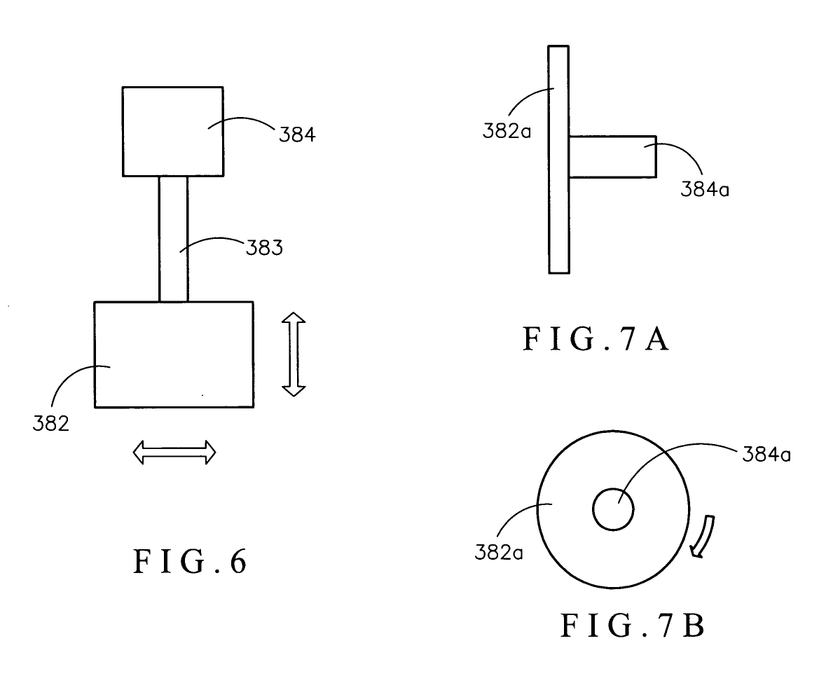

FIG. 6 and FIG. 7 (FIG. 7A and FIG. 7B) illustrate two types of the diffusion module. However, the diffusion module of the present invention is not limited to the two types.

Referring to FIG. 6, the actuator 384 of the diffusion module drives the diffuser 382 to move up and down, left and right (as arrows shown) at a predetermined frequency. The actuator 384 and the diffuser 382 are connected by a connecting mechanism 383 which includes an electric circuit and a mechanical structure.

Referring to FIG. 7A and FIG. 7B, in another embodiment, the diffuser 382a of the diffusion module is a disc and the actuator is a motor 384a that drives the diffuser 382a to rotate.

The above embodiments use a lens, such as a relay lens or an f-theta lens, to focus the image generated by the image generating module on a movable or rotatable diffuser to solve the problem of laser speckles.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to manufacturers skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A laser projection system, comprising:
a plurality of laser light sources, for providing a plurality of laser light beams with different colors;
a light combining module, disposed in the light path of the laser light beams for mixing the laser beams to form a mixing light beam;
an image generating module, disposed in the light path of the mixing light beam for receiving the mixing light beam to generate a first image;
a lens, disposed in the transmitting path of the first image for providing an imaging position, wherein the first image is capable of passing through the lens to form a second image at the imaging position;
a diffusion module, comprising a diffuser and an actuator, wherein the diffuser is disposed at the imaging position of the lens, and the actuator is connected to the diffuser; and
a projection lens, disposed in the transmitting path of the second image for projecting the second image on a screen.

2. The laser projection system of claim 1, wherein the image generating module comprises a transparent liquid crystal panel.

3. The laser projection system of claim 2, further comprising an illuminating module disposed in the light path of the mixing light beam and between the light combining module and the transparent liquid crystal panel, wherein the illuminating module comprises a focus lens, an integration rod, and a plurality of relay lenses, and the focus lens is disposed between the light combining module and the integration rod, and the integration rod is disposed between the focus lens and the relay lenses.

4. The laser projection system of claim 1, wherein the lens is a relay lens.

5. The laser projection system of claim 1, wherein the image generating module comprises a reflective liquid crystal panel and a polarization beam splitter.

6. The laser projection system of claim 5, further comprising an illuminating module disposed in the light path of the mixing light beam and between the light combining module and the reflective liquid crystal panel, wherein the illuminating module comprises a fly eye lens and a plurality of relay lenses, and the fly eye lens is disposed between the light combining module and the relay lenses.

7. The laser projection system of claim 1, wherein the image generating module comprises a plurality of one-dimensional scanning lenses.

8. The laser projection system of claim 7, wherein the lens is an f-theta lens.

9. The laser projection system of claim 1, wherein the actuator of the diffusion module comprises a motor for rotating the diffuser, and the diffuser is a disc.

10. The laser projection system of claim 1, wherein the actuator of the diffusion module is capable of driving the diffuser moving back and forth in two different directions in a preset frequency selectively.

11. The laser projection system of claim 1, wherein the laser light sources comprises a red laser light source, a blue laser light source, and a green laser light source, and the light combing module comprises two parallel dichroic mirrors.
